(19) United States
(12) Patent Application Publication
(10) Pub. No.: US 2024/0188191 A1
(43) Pub. Date: Jun. 6, 2024

(54) COMPOSITE HEATING FILM AND MANUFACTURING METHOD THEREFOR

(71) Applicant: IUCF-HYU (INDUSTRY-UNIVERSITY COOPERATION FOUNDATION HANYANG UNIVERSITY), Seoul (KR)

(72) Inventors: Tae Hee HAN, Seoul (KR); Dong Jun KANG, Seoul (CN); Sung Hyun NOH, Seoul (KR); Ki Hyun LEE, Daejeon (KR)

(73) Assignee: IUCF-HYU (INDUSTRY-UNIVERSITY COOPERATION FOUNDATION HANYANG UNIVERSITY), Seoul (KR)

(21) Appl. No.: 18/286,004

(22) PCT Filed: Apr. 8, 2022
(86) PCT No.: PCT/KR2022/005132

§ 371 Date: Dec. 13, 2023

(30) Foreign Application Priority Data
Apr. 9, 2021 (KR) 10-2021-0046292

(51) Int. Cl. H05B 3/14; B22F 3/00; B22F 5/00; H05B 3/20

(52) U.S. Cl. CPC H05B 3/14; B22F 3/001; B22F 5/006; H05B 3/20; H05B 2203/016; H05B 2203/017

(57) ABSTRACT

Provided is a composite heating film. The composite heating film includes conductive sheets stacked in a layered structure. Metal/metal oxide composite particles intercalated between neighboring conductive sheets among the conductive sheets are positioned. The composite heating film can generate heat with high efficiency even at a low operating voltage and can be used as a portable heating unit due to having a light weight.

### TECHNICAL FIELD

The present invention relates to a heating material, and more specifically, to a heating film.

### BACKGROUND ART

As existing heating materials, nichrome wires, copper wires, Kanthal (Fe—Cr—Al alloy), and the like have been used. In order to overcome the limitations of existing materials, such as low efficiency, opacity, a heavy weight, and a low rate of temperature increase, heating units using advanced materials have been developed, and there are those using graphene, carbon nanotubes, and reduced graphene oxide (rGO).

In the case of using graphene, there is an example in which a transparent heating unit is manufactured by applying graphene onto a substrate and used as a haze removal film, and when carbon nanotubes are used, there is an example in which a film is obtained from the “forest” in which single-walled carbon nanotubes grow and used as a transparent heating unit for automotive windows. However, the heating unit using graphene has disadvantages such as difficulty in mass production and a high cost.

In addition, in the case of using rGO, there are an example in which a transparent heating unit is manufactured by applying graphene oxide onto a substrate through spin coating and an example in which a heating woven fabric is manufactured by manufacturing it in the form of a fiber. However, the heating unit using rGO has a disadvantage such as excessive power consumption because heating efficiency is not high enough to be similar to that of CNTs.

### DISCLOSURE

### Technical Problem

The present invention is directed to providing a method of manufacturing a film which has high efficiency, a low operating voltage, and a light weight and does not need a substrate, and a heating unit using the same.

However, the technical objectives of the present invention are not limited to those described above, and other unmentioned technical objectives will be clearly understood by those skilled in the art from the following description.

### Technical Solution

One aspect of the present invention provides a composite heating film. The composite heating film includes conductive sheets stacked in a layered structure. Metal/metal oxide composite particles intercalated between neighboring conductive sheets among the conductive sheets are positioned.

The conductive sheet may be a two-dimensional material. The conductive sheet may be graphene, graphene oxide (GO), reduced graphene oxide (rGO), MXenes, transition metal dichalcogenides (TMDCs), or a combination thereof.

The metal/metal oxide composite particle may include a metal oxide particle and a metal part provided at a portion of the metal oxide particle. The metal part may be made by locally reducing a portion of the surface or inside of the metal oxide particle. The metal oxide particle may be an insulator, and the metal part may be a conductor. The metal part may be a conductive pathway electrically connecting the conductive sheets.

The metal/metal oxide composite particle may be a phase-separated mixture of a metal oxide and a metal reduced therefrom. The metal/metal oxide composite particle may have a higher atomic ratio of a metal ion compared to a metal (M⁰) having an oxidation number of 0.

Another aspect of the present invention provides a method of manufacturing the composite heating film according to one aspect. First, a conductive sheet dispersion solution in which a conductive sheet is dispersed in a dispersion medium is obtained. A metal oxide precursor is added to the conductive sheet dispersion solution. A film is formed using the conductive sheet dispersion solution to which the metal oxide precursor is added. The film is reduced through thermal treatment to manufacture the composite heating film.

The conductive sheet in the conductive sheet dispersion solution may have a liquid crystal phase. The conductive sheet may be a graphene oxide sheet. The metal oxide precursor may be a metal salt including a metal cation and anion. A temperature of the thermal treatment may be higher than a temperature at which the metal cation is reduced. The thermal treatment temperature may range from 700 to 900° C. The formation of a film may be performed by a filtration or coating method.

Still another aspect of the present invention provides a heating element. The heating element includes the composite heating film according to one aspect of the present invention and a pair of electrodes electrically connected to the composite heating film.

### Advantageous Effects

As described above, the present invention provides a composite heating film including metal/metal oxide composite particles intercalated between a plurality of conductive sheets stacked in a layered structure, and a method of manufacturing the same. The composite heating film can generate heat with high efficiency even at a low operating voltage and can be used as a portable heating unit due to having a light weight.

However, the effects of the present invention are not limited to the above-described effects, and other effects which are not described herein will be fully understood by those skilled in the art from the following descriptions.

### DESCRIPTION OF DRAWINGS

FIG. 1 is a schematic diagram of a composite heating film according to an embodiment of the present invention.

FIG. 2 is a schematic diagram showing the heat generation mechanism of a composite heating film according to an embodiment of the present invention.

FIG. 3 is a schematic diagram of a heating element according to an embodiment of the present invention.

FIG. 4 is a schematic diagram showing the localized heating phenomenon of a composite heating film according to an embodiment of the present invention.

FIG. 5 is a schematic diagram of a method of manufacturing a composite heating film according to an embodiment of the present invention.

FIGS. 6, 7, and 8 show the atomic force microscope (AFM) topology images (a), C-AFM current mapping images (b), transmission electron microscope (TEM) images of particles (c), selected area electron diffraction (SAED) pattern of the area indicated in the TEM images (d), high-resolution transmission electron microscope (HR-TEM) images (e), fast Fourier transform (FFT) signal of the part indicated in the HR-TEM images (f), and X-ray diffraction (XRD) patterns (g) of heating films according to Preparation Examples 2, 1, and 6, respectively.

FIG. 9 shows the schematic diagrams (a), scanning electron microscope (SEM) images of the surface (b, c, d), SEM images between rGO layers (e, f, g), and enlarged images of the parts indicated in SEM images between rGO layers (h, i, j) of heating films according to Preparation Examples 2, 1, and 6.

FIG. 10 shows the Ni 2p X-ray photoelectron spectroscopy (XPS) spectra (a, b, c) and atomic ratio graph of Ni⁰, Ni²⁺, and Ni³⁺ (d) of heating films according to Preparation Examples 2, 1, and 6.

FIG. 11 is a graph showing the power density versus heating temperature of heating films of Preparation Examples 1 to 6.

FIG. 12 is a graph showing the power density versus heating temperature of heating films of Preparation Examples 1 and 7 to 10.

### MODES OF THE INVENTION

Hereinafter, embodiments of the present invention will be described in detail with reference to the accompanying drawings.

While the present invention is susceptible to various modifications and alternative forms, specific embodiments thereof are shown by way of example in the drawings and will herein be described in detail. However, it should be understood that there is no intent to limit the present invention to the particular forms disclosed, but on the contrary, the present invention is to cover all modifications, equivalents, and alternatives falling within the spirit and scope of the present invention.

It will be understood that, when an element such as a layer, a region, or a substrate is referred to as being “on” another element, it can be directly on the other element or intervening elements may be present.

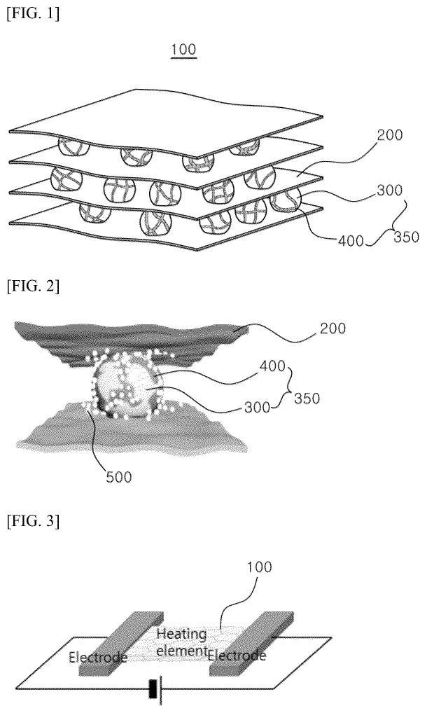

FIG. 1 is a schematic diagram of a composite heating film according to an embodiment of the present invention, and FIG. 2 is a schematic diagram showing the heat generation mechanism of a composite heating film according to an embodiment of the present invention.

Referring to FIGS. 1 and 2, a composite heating film 100 includes conductive sheets 200 stacked in a layered structure and one or more metal/metal oxide composite particles 350 positioned between neighboring conductive sheets 200 among the conductive sheets.

A plurality of the conductive sheets 200 may be stacked in the composite heating film 100. Specifically, two to several hundreds of conductive sheets 200 may be stacked in the composite heating film 100. The conductive sheet 200 may be a carbon-based material such as graphene, graphene oxide (GO), reduced graphene oxide (rGO), carbon nanotubes, graphite, or the like, a non-carbon-based material such as MXenes, transition metal dichalcogenides (TMDCs), or the like, an organic material such as a conductive polymer or the like, or a combination thereof. In an example, the conductive sheets 200 may be a two-dimensional material and may be, for example, graphene, GO, rGO, MXenes, TMDCs, or a combination thereof.

Each conductive sheet 200 may have a thickness of several angstroms to several nanometers and a width of several tens of nanometers to several micrometers. In an embodiment, the conductive sheets 200 may be rGO sheets. In this case, each rGO sheet may have a plate-shaped structure in which one to several tens of graphene atomic layers are stacked and have a thickness of several angstroms to several nanometers and a width of several tens of nanometers to several micrometers.

The metal/metal oxide composite particles 350 may be intercalated between neighboring conductive sheets 200 and electrically connected to the conductive sheets 200 adjacent to the upper and lower parts thereof. In this case, the metal/metal oxide composite particles 350 may be named bridging particles electrically connecting the conductive sheets 200 adjacent to the upper and lower parts thereof. When a plurality of the metal/metal oxide composite particles 350 are positioned in the same layer, they may be separately positioned. Accordingly, although it varies depending on the atmosphere in which the composite heating film 100 is located, when the composite heating film 100 is located in air, air may be filled between the metal/metal oxide composite particles 350.

The metal/metal oxide composite particle 350 may include a metal oxide particle 300 and a metal part 400 provided at a portion of the metal oxide particle 300. The metal part 400 may be made by locally reducing a portion of the surface or inside of the metal oxide particle 300 and may be composed of a metal (M⁰) having an oxidation number of 0. The metal/metal oxide composite particle 350 may be a phase-separated mixture of a metal oxide and a metal reduced therefrom.

In the metal/metal oxide composite particle 350, as the metal part 400 is formed by locally reducing only a portion of the surface and/or inside of the metal oxide particle 300, among metal elements in the metal/metal oxide composite particle 350, the atomic ratio of a metal (M⁰) which constitutes the metal part 400 and has an oxidation number of 0 may be 30 to 60 at %, and the remainder may be an oxidized metal ion (Mⁿ⁺, n is 1 or more and 3 or less) which is present as a metal oxide and has an oxidation number of 1 or more. In an example, the metal/metal oxide composite particle 350 may have a higher atomic ratio of an oxidized metal ion (Mⁿ⁺, n is 1 or more and 3 or less) which is present as a metal oxide and has an oxidation number of 1 or more compared to a metal (M⁰) which constitutes the metal part 400 and has an oxidation number of 0. In an embodiment, among metal elements in the metal/metal oxide composite particle 350, the atomic ratio of a metal (M⁰) which constitutes the metal part 400 and has an oxidation number of 0 may be 35 to 45 at %.

The metal oxide particle 300 may be an insulator, and the metal part 400 may be a conductor. Therefore, the metal part 400 may be a conductive pathway electrically connecting the conductive sheets 200. However, since the metal part 400 is made by locally reducing a portion of the surface or inside of the metal oxide particle 300, the conductive pathway is very narrow. Accordingly, when electrons move via the pathway, current crowding occurs, and thus efficient Joule heating may be performed. Therefore, the composite heating film 100 may exhibit a high heating temperature even at a low power density. In an example, the metal part 400 may appear in the form of a metal wire. One or several metal parts 400 may be present on the surface of the metal oxide particle 300 and may electrically connect the conductive sheets 200.

The metal oxide particle 300 may include Cu oxide, Sn oxide, Pb oxide, Ni oxide, Si oxide, Ti oxide, Al oxide, Mg oxide, Ca oxide, Fe oxide, Zn oxide, Cr oxide, or Mn oxide. In an example, the metal oxide particle 300 may be any one of SnO₂, HgO, CuO, CO₃O₄, Fe₂O₃, PbO₂, and NiO, but the present invention is not limited thereto, and any particle may be used as long as the reduction potential of a metal ion included in the particle is at a temperature of 700 to 900° C. Also, the metal part 400 may be a metal made by reducing the metal ion included in the metal oxide particle 300, that is, Sn, Hg, Cu, Co, Fe, Pb, or Ni.

In addition, the metal/metal oxide composite particle 350 may be a nano-sized particle and may be an approximately spherical particle having a diameter of several to several hundreds of nanometers, for example, 10 to 500 nm.

FIG. 3 is a schematic diagram of a heating element according to an embodiment of the present invention.

Referring to FIG. 3, a heating element may be in the form in which a pair of electrodes are electrically connected to the plate-shaped composite heating film 100 described with reference to FIGS. 1 and 2. When voltage is applied to the electrodes, current flows through the composite heating film 100 including the conductive sheets (200 in FIG. 1) and the metal/metal oxide composite particles (350 in FIG. 1), specifically, the metal part (400 in FIG. 1) positioned therebetween as a conductive pathway, and accordingly, Joule heating may occur.

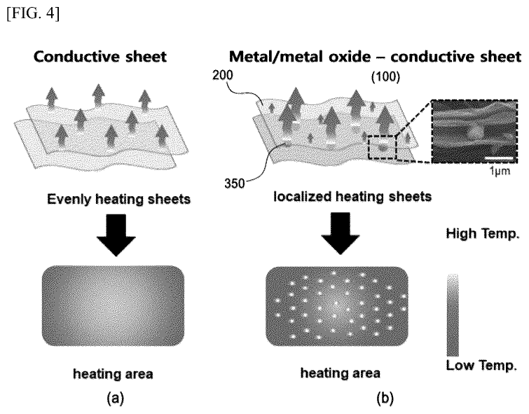

FIG. 4 is a schematic diagram showing the localized heating phenomenon of a composite heating film according to an embodiment of the present invention.

Referring to FIG. 4, when a conductive sheet laminate in which metal/metal oxide composite particles are not intercalated is used as a heating film, overall even heat distribution can be seen (a). However, in the case of a metal/metal oxide-conductive sheet composite heating film 100 which is a conductive sheet laminate in which metal/metal oxide composite particles 350 are intercalated, current crowding occurs in the part in which the metal/metal oxide composite particles 350 are positioned, and thus localized heating occurs. Therefore, a temperature resulting from Joule heating in this part may be higher than other parts (b). Accordingly, as compared to the conductive sheet laminate (a) in which metal/metal oxide composite particles are not intercalated, the metal/metal oxide-conductive sheet composite heating film 100 exhibits a higher maximum surface temperature even when the same amount of energy is applied, and thus heat may be efficiently generated.

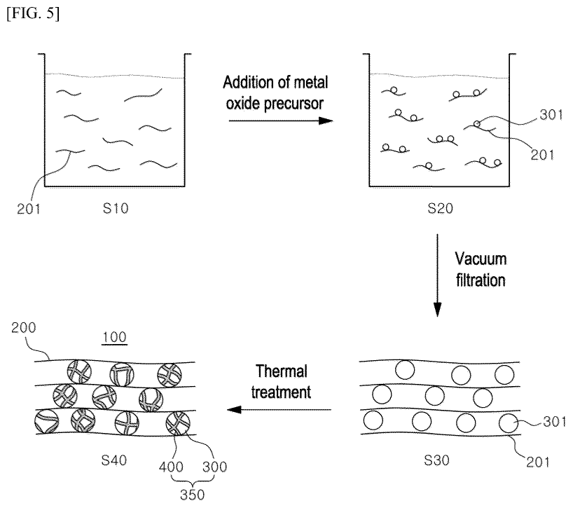

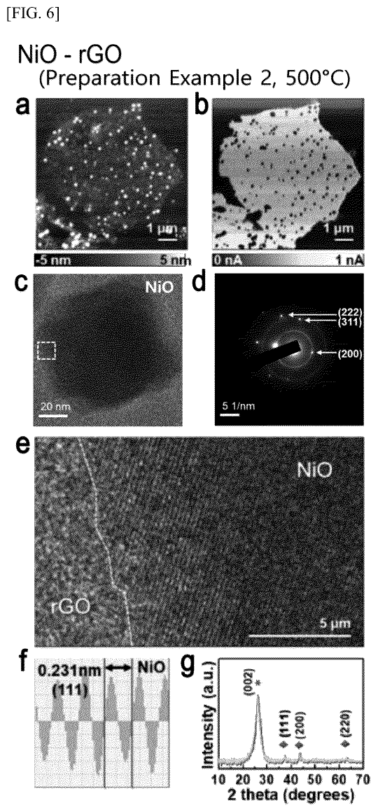

FIG. 5 is a schematic diagram of a method of manufacturing a composite heating film according to an embodiment of the present invention. Since a composite heating film manufactured according to this embodiment has been described with reference to FIGS. 1 and 2, contents that overlap with those described with reference to FIGS. 1 and 2 will be omitted.

Referring to FIG. 5, first, a dispersion solution of a conductive sheet 201 is prepared (S10). In the conductive sheet dispersion solution, the conductive sheet 201 may have a liquid crystal phase.

The conductive sheet 201 may be the conductive sheet described with reference to FIG. 1, and in an example, the conductive sheet 201 may be a graphene oxide sheet (GO sheet). The GO sheet may have a thickness of 1 nm to 100 nm and have, for example, a structure in which one to several or several tens of graphene atomic layers are stacked. Specifically, the GO sheet may have one to a few graphene atomic layers. The a few graphene atomic layers may refer to 2 to 5 graphene atomic layers. Also, the GO sheets may have an average size of 1 to 20 μm, for example, 2 to 15 μm, specifically, several nanometers. An oxygen-containing functional group such as —OH, —COOH, or an epoxy group may be bonded to the edge and upper and lower surfaces of the GO sheet.

As a dispersion medium in the dispersion solution, any dispersion medium may be used as long as the conductive sheet 201 has a liquid crystal phase. When the conductive sheet 201 is a GO sheet, the dispersion medium may be a polar solvent, for example, a polar organic solvent such as dimethyl sulfoxide (DMSO), dimethylacetamide, dimethylformamide (DMF), N-methyl pyrrolidone, or the like, or water.

A metal oxide precursor may be added to the conductive sheet dispersion solution (S20). As the metal oxide precursor, any metal oxide precursor that is able to form any one metal oxide selected from the group consisting of SnO₂, HgO, CuO, CO₃O₄, Fe₂O₃, PbO₂, and NiO may be used without limitation, and specifically, the metal oxide precursor may be a metal salt or a C1 to C4 metal alkoxide. The metal salt may be metal halides (here, a halide may be F⁻, Cl⁻, Br⁻, or I⁻), metal sulfides, metal nitrides, metal phosphates, metal hydrogen phosphates, metal dihydrogen phosphates, metal sulfates, metal nitrates, metal hydrogen sulfates, metal nitrites, metal sulfites, metal perchlorates, metal iodates, metal chlorates, metal bromates, metal chlorites, metal hypochlorites, metal hypobromites, metal carbonates, metal chromates, metal hydrogen carbonates, metal dichromates, metal acetates, metal formates, metal cyanide, metal amides, metal cyanates, metal peroxides, metal thiocyanates, metal oxalates, metal hydroxides, or metal permanganates. In an embodiment, the metal oxide precursor may be a nickel oxide precursor, and the nickel oxide precursor may be nickel chloride (NiCl₂).

The metal oxide precursor may be added in the form of a solution to the conductive sheet dispersion solution. In this case, a solvent in the metal oxide precursor solution may be an alcohol such as methanol, ethanol, propanol, or the like, water, or a mixture thereof.

The metal oxide precursor added to the conductive sheet dispersion solution dissociates into a metal cation 301, and then the metal cation 301 may be bonded to the surface of the conductive sheet 201. In an example, when the conductive sheet 201 is a GO sheet, the oxygen-containing functional group of the GO sheet and the metal cation may be bonded by electrostatic interaction.

A film may be formed using the conductive sheet dispersion solution to which the metal oxide precursor is added (S30). The formation of a film may be performed by filtration or coating. The filtration may be filtration under reduced pressure such as vacuum filtration or the like, and the coating may be spin coating, bar coating, spray coating, or dip coating. Also, the metal cation 301 in the film may be in the form in which it is bonded to the surface of the conductive sheet 201.

Afterward, the film may be reduced through thermal treatment (S40). A temperature of the thermal treatment may be higher than a temperature at which the metal cation is reduced. In an example, when the metal cation is a nickel ion, the thermal treatment temperature may be 700 to 900° C., specifically 750 to 850° C., and more specifically 780 to 820° C. An atmosphere for thermally treating the film may be a nitrogen atmosphere or an inert gas atmosphere, for example, an argon atmosphere.

When the film is thermally treated, the metal cation 301 bonded to the conductive sheet 201 is changed into a metal oxide seed, and neighboring metal oxide seeds are merged to form a metal oxide particle 300. Afterward, when the temperature further increases, a portion of the surface or inside of the metal oxide particle 300 is locally reduced to form a metal part 400, and thus metal/metal oxide composite particles 350 may be produced.

In an example, when the conductive sheet 201 is a GO sheet, the GO sheet is reduced to form reduced graphene oxide (rGO) when the metal cation 301 is changed into a metal oxide seed. Afterward, when the temperature further increases, for example, when the temperature reaches about 700° C., and specifically, 710° C. or more in the case of nickel, rGO is decomposed to generate CO gas, and the CO gas locally reduces the metal oxide particles 300 to form the metal part 400 and is converted into CO₂ gas.

Hereinafter, exemplary examples will be described for aiding understanding of the present invention. However, the following examples should be considered in a descriptive sense only, and the scope of the present invention is not limited to the examples.

### EXAMPLES

### Preparation Example 1

An aqueous graphene oxide dispersion solution was prepared by chemical exfoliation using a modified Hummer's method and then diluted to 0.1 wt %. Nickel chloride (NiCl₂) as a metal oxide precursor was added to an aqueous methanol solution in which water and methanol were mixed in a ratio of 1:9 to obtain a 3.3 wt % metal oxide precursor solution. 4 ml of the 3.3 wt % metal oxide precursor solution was added dropwise to 18 ml of the 0.1 wt % aqueous graphene oxide dispersion solution and mixed. In the resulting mixture, nickel was contained at a ratio of 4 mg per 20 mg of graphene oxide. At this time, vigorous stirring was performed to prevent agglomeration at the point where the aqueous graphene oxide dispersion solution and the metal oxide precursor solution come into contact with each other. After stirring was performed for about 30 minutes, the resultant was filtered under reduced pressure through a PVDF filter having a pore size of 0.45 μm to form a film. The manufactured film was heated to 800° C. at a temperature increase rate of 10° C./min under an Ar atmosphere and then thermally treated for 2 hours to obtain a heating film.

### Preparation Example 2

A heating film was obtained in the same manner as in Preparation Example 1, except that the film filtered under reduced pressure was heated to 500° C. at a temperature increase rate of 10° C./min under an Ar atmosphere and then thermally treated for 2 hours.

### Preparation Example 3

A heating film was obtained in the same manner as in Preparation Example 1, except that the film filtered under reduced pressure was heated to 600° C. at a temperature increase rate of 10° C./min under an Ar atmosphere and then thermally treated for 2 hours.

### Preparation Example 4

A heating film was obtained in the same manner as in Preparation Example 1, except that the film filtered under reduced pressure was heated to 700° C. at a temperature increase rate of 10° C./min under an Ar atmosphere and then thermally treated for 2 hours.

### Preparation Example 5

A heating film was obtained in the same manner as in Preparation Example 1, except that the film filtered under reduced pressure was heated to 900° C. at a temperature increase rate of 10° C./min under an Ar atmosphere and then thermally treated for 2 hours.

### Preparation Example 6

A heating film was obtained in the same manner as in Preparation Example 1, except that the film filtered under reduced pressure was heated to 1000° C. at a temperature increase rate of 10° C./min under an Ar atmosphere and then thermally treated for 2 hours.

### Preparation Example 7

A heating film was obtained in the same manner as in Preparation Example 1, except that, as 1 ml of the 3.3 wt % metal oxide precursor solution was used, nickel was contained at a ratio of 1 mg per 20 mg of graphene oxide in a mixture of the aqueous graphene oxide dispersion solution and the metal oxide precursor solution.

### Preparation Example 8

A heating film was obtained in the same manner as in Preparation Example 1, except that, as 2 ml of the 3.3 wt % metal oxide precursor solution was used, nickel was contained at a ratio of 2 mg per 20 mg of graphene oxide in a mixture of the aqueous graphene oxide dispersion solution and the metal oxide precursor solution.

### Preparation Example 9

A heating film was obtained in the same manner as in Preparation Example 1, except that, as 3 ml of the 3.3 wt % metal oxide precursor solution was used, nickel was contained at a ratio of 3 mg per 20 mg of graphene oxide in a mixture of the aqueous graphene oxide dispersion solution and the metal oxide precursor solution.

### Preparation Example 10

A heating film was obtained in the same manner as in Preparation Example 1, except that, as 6 ml of the 3.3 wt % metal oxide precursor solution was used, nickel was contained at a ratio of 6 mg per 20 mg of graphene oxide in a mixture of the aqueous graphene oxide dispersion solution and the metal oxide precursor solution.

### Comparative Example

An aqueous graphene oxide dispersion solution was prepared by chemical exfoliation using a modified Hummer's method and then diluted to 0.1 wt %. The 0.1 wt % aqueous graphene oxide dispersion solution was filtered under reduced pressure through a PVDF filter having a pore size of 0.45 μm to form a film. The manufactured film was heated to 800° C. at a temperature increase rate of 10° C./min under an Ar atmosphere and then thermally treated for 2 hours to obtain a heating film.

In the following Table 1, the main process factors in the manufacture of heating films according to Preparation Examples 1 to 10 and Comparative Example are summarized.

TABLE 1

| | Nickel content | Reduction temperature |
|---|---|---|
| | (mg/GO 20 mg) | (° C.) |
| Preparation Example 1 | 4 | 800 |
| Preparation Example 2 | 4 | 500 |
| Preparation Example 3 | 4 | 600 |
| Preparation Example 4 | 4 | 700 |
| Preparation Example 5 | 4 | 900 |
| Preparation Example 6 | 4 | 1000 |
| Preparation Example 7 | 1 | 800 |
| Preparation Example 8 | 2 | 800 |
| Preparation Example 9 | 3 | 800 |
| Preparation Example 10 | 6 | 800 |
| Comparative Example | 0 | 800 |

FIGS. 6, 7, and 8 show the atomic force microscope (AFM) topology images (a), C-AFM current mapping images (b), transmission electron microscope (TEM) images of particles (c), selected area electron diffraction (SAED) pattern of the area indicated in the TEM images (d), high-resolution transmission electron microscope (HR-TEM) images (e), fast Fourier transform (FFT) signal of the part indicated in the HR-TEM images (f), and X-ray diffraction (XRD) patterns (g) of heating films according to Preparation Examples 2, 1, and 6, respectively.

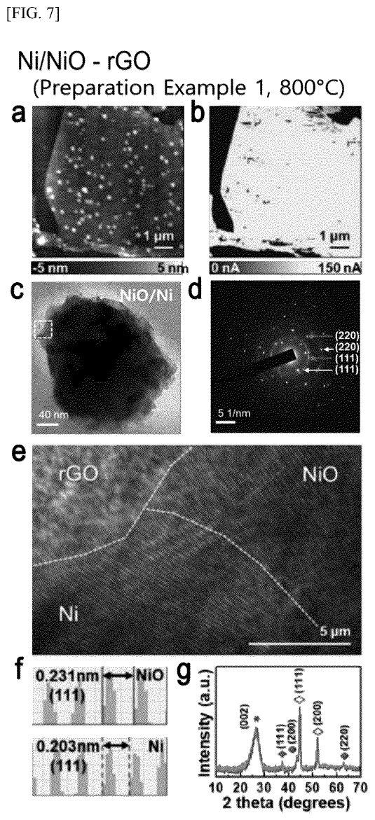

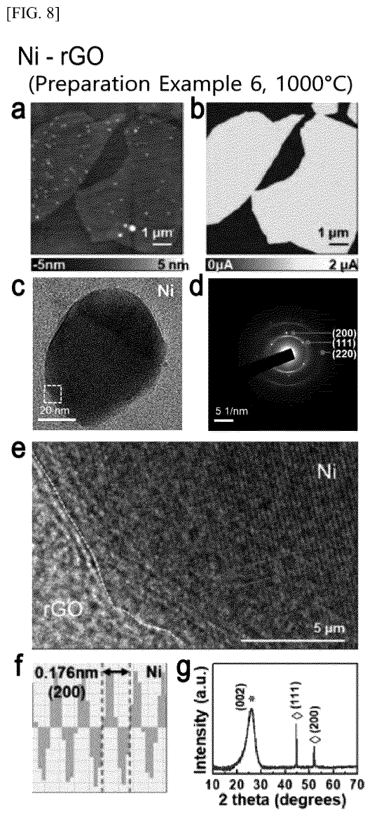

Referring FIGS. 6, 7, and 8, in XRD patterns (g), a (002) peak was exhibited, and from this result, it can be seen that a graphene oxide (GO) sheet was reduced to a reduced graphene oxide (rGO) sheet even at the lowest thermal treatment temperature of 500° C. In addition, in the case of Preparation Example 2 in which reductive thermal treatment was performed at 500° C., (111), (200), and (220) peaks corresponding to NiO were exhibited at 37.2°v, 43.2°, and 62.8°, respectively, and from this result, it was determined that NiO particles having a face centered cubic phase (FCC phase) crystal structure were produced (g of FIG. 6). A d-spacing between the (111) planes was found to be 0.231 nm (f of FIG. 6). In the case of Preparation Example 6 in which reductive thermal treatment was performed at 1000° C., (111) and (200) peaks corresponding to Ni were exhibited at 44.5° and 51.7°, respectively, and from this result, it was determined that Ni particles having a crystal structure were produced (g of FIG. 8), and a d-spacing between the (200) planes was found to be 0.176 nm (f of FIG. 8). Meanwhile, in the case of Preparation Example 1 in which reductive thermal treatment was performed at 800° C., (111), (200), and (220) peaks corresponding to NiO were exhibited at 37.2°, 43.2°, and 62.8°, respectively, and (111) and (200) peaks corresponding to Ni were also exhibited at 44.5° and 51.7°, respectively. From this result, it was determined that Ni/NiO composite particles having a crystal structure were produced (g of FIG. 7), and a d-spacing between the (111) planes of NiO was found to be 0.231 nm, and a d-spacing between the (111) planes of Ni was found to be 0.203 nm (f of FIG. 7).

As described above, in the case of Preparation Example 2 in which reductive thermal treatment was performed at 500° C., it can be confirmed that NiO particles were generated on the rGO sheet (a and g of FIG. 6), and the NiO particle was found to have a diameter of about 90 nm (c of FIG. 6). In the case of Preparation Example 1 in which reductive thermal treatment was performed at 800° C., it can be confirmed that Ni/NiO composite particles were generated on the rGO sheet (a and g of FIG. 7), and the Ni/NiO composite particle was found to be a phase-separated mixture, not an alloy, and have a diameter of about 230 nm (c of FIG. 7). Also, in the case of Preparation Example 6 in which reductive thermal treatment was performed at 1000° C., it can be confirmed that Ni particles were generated on the rGO sheet (a and g of FIG. 8), and the Ni particle was found to have a diameter of about 65 nm (c of FIG. 8).

In addition, referring to the C-AFM current mapping images (b) of FIGS. 6, 7, and 8, it was assumed that the NiO particles of Preparation Example 2 were insulators as they appeared darker than the rGO sheet (b of FIG. 6), the Ni particles of Preparation Example 6 were conductors having a similar resistance to rGO as they were displayed at a brightness similar to that of the rGO sheet (b of FIG. 8), and the Ni/NiO composite particles of Preparation Example 1 was assumed to have a resistance higher than that of the Ni particles and lower than that of the NiO particles (b of FIG. 7).

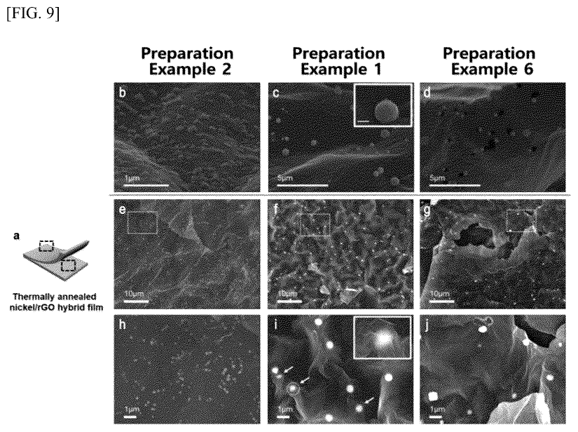

FIG. 9 shows the schematic diagrams (a), scanning electron microscope (SEM) images of the surface (b, c, d), SEM images between rGO layers (e, f, g), and enlarged images of the parts indicated in SEM images between rGO layers (h, i, j) of heating films according to Preparation Examples 2, 1, and 6.

Referring to FIG. 9, it can be seen that particles were positioned on the surface of the heating film and between the rGO layers. Particularly, particles (i.e., Ni/NiO composite particles; i) in the heating film according to Preparation Example 1 had a larger size than particles (i.e., NiO particles; h) in the heating film according to Preparation Example 2, and it was assumed that the composite particles grow as neighboring NiO particles merged. Meanwhile, it was shown that holes were generated in the rGO sheet around the Ni particles according to Preparation Example 6 (d, g, j), and it was assumed that CO was produced by thermally oxidizing carbon in the rGO sheet during reductive thermal treatment, and thus the rGO sheet was partially damaged.

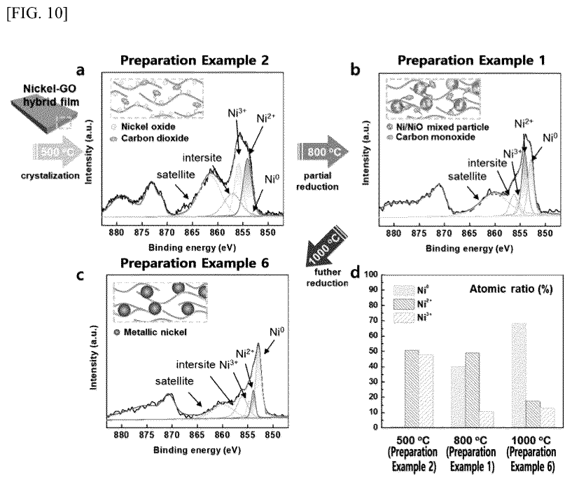

FIG. 10 shows the Ni 2p X-ray photoelectron spectroscopy (XPS) spectra (a, b, c) and atomic ratio graph of Ni⁰, Ni²⁺, and Ni³⁺ (d) of heating films according to Preparation Examples 2, 1, and 6. The peaks in (a), (b), and (c) were deconvoluted for Ni⁰, Ni²⁺, and Ni³⁺, and the atomic ratio of Ni⁰, Ni²⁺, and Ni³⁺ were calculated and shown in (d). Also, the insets in (a), (b), and (c) show the structures of the heating film.

Referring to FIG. 10, when a thermal treatment temperature was 500° C., the atomic ratio of metallic nickel (Ni⁰) shows a value close to 0 (Preparation Example 2), and when a thermal treatment temperature was 800° C., the atomic ratio of metallic nickel (Ni⁰) shows a value close to about 40 at % (Preparation Example 1), and when a thermal treatment temperature was 1000° C., the atomic ratio of metallic nickel (Ni⁰) shows a value close to about 70 at % (Preparation Example 6). Meanwhile, Preparation Example 1 in which thermal treatment was performed at 800° C. exhibited a higher atomic ratio of oxidized nickel (Ni²⁺ and Ni³⁺) compared to metallic nickel (Ni⁰) and a higher atomic ratio of nickel (Ni²⁺) having an oxidation number of 2 compared to metallic nickel (Ni⁰), whereas Preparation Example 6 in which thermal treatment was performed at 1000° C. exhibited a lower atomic ratio of oxidized nickel (Ni²⁺ and Ni³⁺) compared to metallic nickel (Ni⁰) and a lower atomic ratio of nickel (Ni²⁺) having an oxidation number of 2 compared to metallic nickel (Ni⁰). From these results, it can be seen that, when a thermal treatment temperature was 800° C. as in Preparation Example 1, a portion of the NiO particle was reduced to Ni, and when a thermal treatment temperature was 1000° C. as in Preparation Example 6, most of the NiO particle was reduced to Ni.

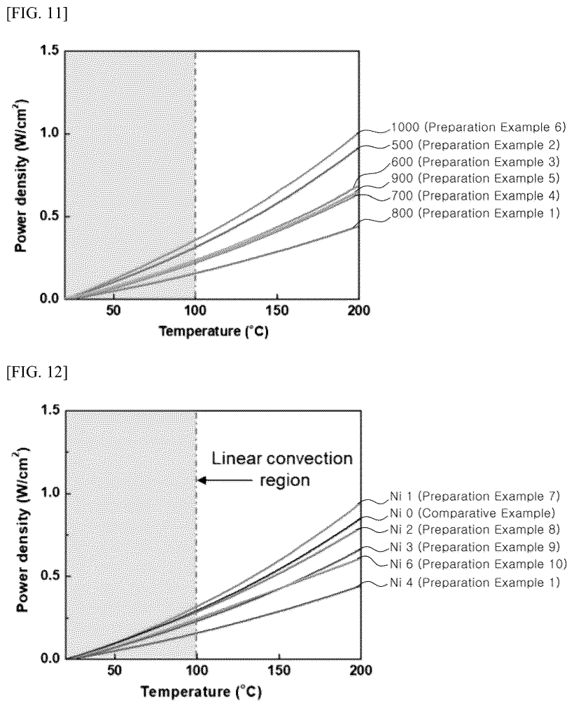

FIG. 11 is a graph showing the power density versus heating temperature of heating films of Preparation Examples 1 to 6.

Referring to FIG. 11, when a thermal treatment temperature was 800° C. (Preparation Example 1), the power density consumed to exhibit a heating temperature of 100° C. was the lowest. Also, when thermal treatment temperatures were 700° C. (Preparation Example 4), 600° C. (Preparation Example 3), and 900° C. (Preparation Example 5), the power density consumed to exhibit a heating temperature of 100° C. was higher compared to when a thermal treatment temperature was 800° C. (Preparation Example 1) and was lower compared to when thermal treatment temperatures were 500° C. (Preparation Example 2) and 1000° C. (Preparation Example 6).

From these results, in the case of Preparation Examples 1 and 3 to 5, particularly, Preparation Example 1, it can be seen that particles in which a portion of the NiO particle was reduced to Ni were positioned between the reduced graphene sheets, and thus high Joule heating efficiency was exhibited, as compared to Preparation Example 2 in which NiO particles were positioned between the reduced graphene sheets or Preparation Example 6 in which Ni particles were positioned between the reduced graphene sheets. Accordingly, it can be seen that, when a reductive thermal treatment temperature is 700 to 900° C., specifically, 800° C., only a portion of the NiO particle is reduced to Ni, and thus Joule heating efficiency is improved.

FIG. 12 is a graph showing the power density versus heating temperature of heating films of Preparation Examples 1 and 7 to 10.

Referring to FIG. 12, Preparation Examples 1, 9, and 10 in which nickel was contained in an amount of 3 to 6 mg with respect to 20 mg of graphene oxide exhibited relatively low power densities consumed to exhibit a heating temperature of 100° C., and furthermore, Preparation Example 1 in which nickel was contained in an amount of 4 mg with respect to 20 mg of graphene oxide exhibited the lowest power density consumed to exhibit a heating temperature of 100° C. From these results, it can be seen that, when a nickel content of the heating film is 3 to 6 mg, specifically, 4 mg based on 20 mg of graphene, Joule heating efficiency is improved.

The present invention has been described in detail with reference to the exemplary examples but is not limited to the examples. Also, it will be understood by those skilled in the art that various changes and modifications may be made within a range without departing from the technical spirit and the scope of the present invention.

1: A composite heating film comprising:
conductive sheets stacked in a layered structure; and
metal/metal oxide composite particles intercalated between neighboring conductive sheets among the conductive sheets.

2: The composite heating film of claim 1, wherein the conductive sheet is a two-dimensional material.

3: The composite heating film of claim 2, wherein the conductive sheet is graphene, graphene oxide (GO), reduced graphene oxide (rGO), MXenes, transition metal dichalcogenides (TMDCs), or a combination thereof.

4: The composite heating film of claim 1, wherein the metal/metal oxide composite particle includes a metal oxide particle and a metal part provided at a portion of the metal oxide particle.

5: The composite heating film of claim 4, wherein the metal part is made by locally reducing a portion of the surface or inside of the metal oxide particle.

6: The composite heating film of claim 4, wherein the metal oxide particle is an insulator, and the metal part is a conductor.

7: The composite heating film of claim 4, wherein the metal part is a conductive pathway electrically connecting the conductive sheets.

8: The composite heating film of claim 1, wherein the metal/metal oxide composite particle is a phase-separated mixture of a metal oxide and a metal reduced therefrom.

9: The composite heating film of claim 1, wherein the metal/metal oxide composite particle has a higher atomic ratio of a metal ion compared to a metal (M⁰) having an oxidation number of 0.

10: A method of manufacturing a composite heating film, comprising:
obtaining a conductive sheet dispersion solution in which a conductive sheet is dispersed in a dispersion medium;
adding a metal oxide precursor to the conductive sheet dispersion solution;
forming a film using the conductive sheet dispersion solution to which the metal oxide precursor is added; and
reducing the film through thermal treatment to manufacture the composite heating film of claim 1.

11: The method of claim 10, wherein the conductive sheet in the conductive sheet dispersion solution has a liquid crystal phase.

12: The method of claim 10, wherein the conductive sheet is a graphene oxide sheet.

13: The method of claim 10, wherein the metal oxide precursor is a metal salt including a metal cation and anion.

14: The method of claim 13, wherein a temperature of the thermal treatment is higher than a temperature at which the metal cation is reduced.

15: The method of claim 14, wherein the thermal treatment temperature ranges from 700 to 900° C.

16: The method of claim 10, wherein the formation of a film is performed by a filtration or coating method.

17: A heating element comprising:
the composite heating film of claim 1; and
a pair of electrodes electrically connected to the composite heating film.
